(19) United States
(12) Patent Application Publication
(10) Pub. No.: US 2011/0057107 A1
(43) Pub. Date: Mar. 10, 2011

(54) BOLOMETRIC DETECTOR FOR DETECTING ELECTROMAGNETIC WAVES

(75) Inventors: Patrick AGNESE, Voreppe (FR); Agnès Arnaud, St Jean Le Vieux (FR)

(73) Assignee: Commissariat A L'Energie Atomique Et Aux Energies Alternatives, Paris (FR)

(21) Appl. No.: 12/941,261

(22) Filed: Nov. 8, 2010

Related U.S. Application Data
(63) Continuation of application No. PCT/FR2009/051003, filed on May 28, 2009.

(30) Foreign Application Priority Data
Jul. 17, 2008 (FR) 0854857

(51) Int. Cl. G01J 5/10

(52) U.S. Cl. 250/338.3

(57) ABSTRACT

A bolometric detector for detecting electromagnetic radiation comprising a receiving antenna intended for collecting electromagnetic radiation and thus ensuring electromagnetic coupling; a resistive load capacitively coupled to antenna and capable of converting the electromagnetic power collected into calorific power; and a thermometric element connected to resistive load and thermally isolated from a substrate that is capable of accommodating an electronic circuit that includes means of electrical excitation (stimulus) and pre-processing the electrical signals generated by said detector. The resistive load is suspended above receiving antenna by means of a single thermometric element which is itself electrically and mechanically linked to the substrate.

### FIELD OF THE INVENTION

The invention relates to a bolometric detector, more especially one designed to detect electromagnetic waves from the infrared domain into the visible domain and even beyond, i.e. a detector that makes it possible to detect electromagnetic waves having wavelengths of several micrometres down to the submillimetric range (several hundred micrometres) or even the millimetric range.

The detection of millimetric waves and, more especially, submillimetric waves has a certain number of attractions, especially on a scientific and technological level. Its known application areas include remote sensing, astrophysics in particular, but also imagers, radio astronomy from ground-based telescopes, biomedical imaging, etc.

There are currently two known different physical principles that are used for detecting millimetric and submillimetric waves.

The first of these involves detecting the electromagnetic waves by means of an antenna so as to create an electrical signal which is processed by an electronic circuit that operates at the frequency of the wave. The drawback of detectors that operate using this first principle is that they are extremely limited in terms of frequency.

In addition, given the fact that such detectors are generally arranged in an array structure, the heat dissipation of the corresponding circuits is relatively high, of the order of 1 Watt for a 32×32 array, and this is another drawback.

The second known technical principle involves using an antenna to detect electromagnetic waves which is able to create a heat flux, measurement of which is equivalent to the signal to be detected. The detectors used in conjunction with this principle traditionally consist of bolometric-type detectors.

In a known manner, thermal detectors, the family to which bolometric detectors belong, absorb the power of incident electromagnetic radiation, convert it into a heat which is then converted into a signal as a result of the concomitant temperature increase compared with a reference temperature within a determined range, making it possible to associate these temperature variations with electrical signals that correspond to actual measurement of the incident electromagnetic flux. It is evident, however, that, because a small variation in temperature is measured, said detector must be as thermally isolated as possible.

Due to the effect of incident radiation, the detector warms up and relays this concomitant temperature increase to the thermally sensitive material. This increase in temperature causes a variation in a property of said sensitive material such as the appearance of electric charges due to the pyrolectric effect, a variation in capacitance due to a change in the dielectric constant in the case of capacitive detectors, a variation in voltage due to the thermoelectric effect in the case of thermocouples or a variation in resistance in the case of bolometric detectors.

The use of bolometric detectors is widespread in the field of infrared detection. These detectors classically consist of a suspended membrane which comprises a thin (typically from 0.1 to 1 μm) layer of temperature-sensitive bolometric material, two electrodes and an absorber, the function of which is to pick up the electromagnetic radiation in order to convert it into heat inside the structure thus defined. The membrane is suspended by means of beams above the substrate by anchoring points or fixing studs capable of isolating said membrane from the substrate. These anchoring points or fixing studs, also referred to as “posts”, are used to apply drive potentials or stimuli to the conductive parts or electrodes of the bolometric detector via flat elongated structures that are also referred to as “isolating arms”. These arms therefore conduct electricity but must have the highest possible thermal resistance.

In order to achieve satisfactory performance, the bolometric material, i.e. the sensitive material, must have a low calorific mass, be well thermally isolated from the substrate and, finally, must be highly sensitive in terms of converting a temperature rise into an electrical signal.

In a known manner, the substrate, generally made of silicon, accommodates a readout circuit consisting of an electronic circuit that includes means of sequentially addressing or multiplexing the elementary detectors, means of electric excitation (e.g. stimuli) and means of pre-processing the electrical signals generated by said elementary detectors. This being so, such a readout circuit allows serial conversion of the signals obtained from the various elementary detectors and makes it possible to relay them to a reduced number of outputs so that they can be analysed by a standard imaging system such as, for example, an infrared camera.

Advantageously, in order to optimise the performance of these detectors, they are encapsulated inside a package containing a vacuum or very low-pressure gas and having a window that is transparent to the wavelength band in question.

Traditionally, the bolometric material used consists of p or n type slightly resistive or highly resistive polycrystalline or amorphous silicon but may also be made of vanadium oxide (V₂O₅, VO₂) or of a cuprate (YBaCuO) produced in a semiconductor phase.

The use of such bolometric detectors has been extensively described in relation to detection of infrared wavelengths. For this wavelength range, it is possible to simultaneously fit both thermometric and incident infrared radiation absorption functions on the bolometer matrix.

In fact, a system for detecting electromagnetic radiation has to have dimensions approaching the order of magnitude of the wavelength in question in order to be effective. There is a compromise between the power collected (which is proportional to the surface area of the detector) and the spatial resolution. The diffraction phenomena that are inherent to any optical system limit the spatial resolution to a value of the order of the wavelength in the dimensions of its plane. The ideal dimensions for a detector are therefore of this order of magnitude.

Thus, an array or matrix of infrared detectors having dimensions of 25×25 μm² is capable of accommodating both these functions. This being so, the absorber, i.e. the membrane that supports the sensitive bolometric element, ensures both electromagnetic coupling with the incident radiation and therefore absorption of said radiation and as well as conversion of this radiation into a heat flux due to the Joule effect.

In the field of submillimetric or even millimetric wavelengths, the above logic results in membrane sizes of the same order of magnitude. However, the calorific mass, mechanical strength and radiation losses of a membrane having such dimensions are impossible to envisage throughout the service life of the detectors used, let alone in terms of the quality of the measurements to be made.

Given this, it becomes necessary to separate the electromagnetic coupling function from the function of converting electromagnetic power into calorific power. The first of these two functions is performed by means of a receiving antenna and the second function is performed by a resistive load associated with the antenna.

### DESCRIPTION OF THE PRIOR ART

Such bolometric detection devices with an antenna, capable of operating at temperatures of around 300 K, i.e. ambient temperature, but also capable of operating down to cryotemperatures (as low as T<1 K) are known. These devices use strips or arrays of such detectors.

FIG. 1 shows a diagram illustrating the operating principle of such an antenna bolometer according to the prior art.

This essentially consists of an antenna (1) comprising a conductive layer deposited on a non-conductive substrate (2). It comprises a resistive metal (3) which constitutes both the resistive load of the antenna capable of generating calorific power and the isolating arms of a thermometer or bolometer (4) comprising a thermoresistive material such as, for example, amorphous silicon or vanadium oxide. As can be seen, there is a cavity (5) underneath the thermometer (4) allowing thermal isolation of the latter.

The electric current generated in the antenna (1) by the incident radiation is dissipated in the isolating arms (3) due to the Joule effect.

Advantageously, a reflective metal surface makes it possible to optimise absorption for a given wavelength range. Generally speaking, this reflector is positioned at a distance from the antenna equal to λ/4n, λ being the average wavelength that is to be detected and n being the refractive index of the medium that separates the reflector from the antenna, this is intended to optimise coupling in the antenna.

The need to thermally isolate the actual detector itself, which is made of a bolometric material, in order to allow detection to be optimised, is readily apparent. One of the difficulties that has to be overcome with such detecting devices is the limitation imposed by their actual construction because of the proportionality of thermal conductivity and electric conductivity throughout the conductive material and which takes a simple form in the case of metals: Wiedemann Franz's law.

Thus, the electrical link between the antenna and the thermometer is necessarily accompanied by a thermal link which has a significantly adverse effect on the performance of bolometers since they measure a variation in temperature relative to a reference value.

Document WO 00/40937, for example, describes a detection device which uses such antenna bolometers. The antenna described is a bow-tie type antenna and is placed above a metal surface at a distance equal to a quarter of the operating wavelength of the detector, thereby defining a so-called quarter-wave cavity which is well known in itself. In addition, the thermometer is suspended by the antenna's load resistor. The thermometer consists of a monocrystalline silicon junction diode, thermal isolation of which is obtained by etching the rear surface of the substrate made of silicon.

The special-shaped antenna is deposited on a layer of silicon oxide SiO which, because of the technology used (thin-film type), has a thickness e of the order of one micrometre. A bow-tie type antenna optimised for detection either side of a frequency of 1 THz has a size of roughly half the operating wavelength, i.e. 150×150 μm².

Given this assumption, the antenna is therefore virtually thermally grounded; in other words it is not thermally isolated and because of its mechanical and electrical connection to the thermometer, the latter is not satisfactorily thermally isolated.

In order to overcome this drawback, Document U.S. Pat. No. 6,329,655 proposes a detection device that also uses a bolometric detector. The antenna is of the same type as that in the previous document (bow tie) but capacitive or inductive coupling is introduced between the antenna and the load resistor. Coupling is obtained in the centre of the antenna. The thermometer or bolometer used is of the thermistor type, preferably with vanadium oxide V₂O₅. This coupling nevertheless requires a submicron gap between the antenna and the thermometer and this complicates the technology involved in producing such a detector considerably.

Once again, the antenna is not thermally isolated, only the thermoresistive material which constitutes the thermometer is effectively thermally isolated from the substrate and isolated from the antenna for capacitive optical coupling.

Document FR 2 855 609 also suggests positioning a reflecting surface underneath the bolometer at a distance that is strictly less than a quarter of the operating wavelength. The load resistance of the antenna is then of the order of one kΩ, which is equivalent to a thermal resistance which is still insufficient and therefore limits the performance of the detector. Moreover, such a high load resistance value is necessarily accompanied by a reduction in the absorption bandwidth which has a very negative impact on a passive detector, because the absorbed power is proportional to the bandwidth.

In order to optimise the sought-after thermal isolation, document FR 2 884 608 proposes a bolometric detector of the type in question in which the receiving antenna is itself isolated from the substrate. This solves the problems of ensuring thermal isolation of the thermometer. Nevertheless, the problem of reducing the response time of such detectors and the problem of miniaturising detectors, which is a constant preoccupation for those skilled in the art, without thereby affecting detection properties, still remains.

### SUMMARY OF THE INVENTION

The invention concerns a bolometric detector for electromagnetic radiation comprising:
a receiving antenna intended for collecting electromagnetic radiation and thus ensuring electromagnetic coupling;
a resistive load capacitively coupled to the antenna and capable of converting the electromagnetic power collected into calorific power;
a thermometric element connected to the resistive load and thermally isolated from a substrate, the latter being capable of accommodating an electronic circuit that includes means of electrical excitation (stimulus) and pre-processing the electrical signals generated by said detector.

According to the invention, the resistive load is suspended over the receiving antenna by means of a single thermometric element which is itself electrically and mechanically connected to the substrate.

In other words, the invention involves using the mechanical suspension element of the structure that traditionally consists of the resistive load and the thermometer as a thermometer, thus making it possible to reduce the size of the bolometer (resistive load+thermometer) and hence reduce its heat capacity, thus improving its time response.

Advantageously, the resistive load is located centrally relative to the thermometric element. This being so, the calorific power created by capacitive coupling between the receiving antenna and said load is transferred to the thermometric element which is also centrally located and the heat diffuses along said element either side of the load. At the level of said thermometric element, this creates a temperature gradient between this centralised location and the ends of the thermometric element which is inherent in the actual nature of the material from which it is made.

According to another advantageous aspect of the invention, the resistive load is square or rectangular. Given this assumption, the largest dimension of the rectangle is oriented in the main direction in which the antenna extends. It has a surface area of around several square micrometres and, advantageously, less than 10 μm². More generally, the surface area of the resistive load is advantageously less than 1% of the surface area of the receiving antennas.

According to the invention, the substrate receives a layer of reflective material separated from the antenna by a dielectric material, insulating semiconductor material or organic material or by a vacuum. In the latter case, the antenna is secured by means of supporting it relative to the substrate, for example, by dielectric posts.

This being so, one creates an optical cavity, whereof the thickness is of the order of λ/4n, n being the refractive index of the medium that constitutes the cavity and λ is the average wavelength of the detection domain in question.

According to one advantageous aspect of the invention, the antenna is in the shape of a bow-tie or double bow-tie (in order to take into account the two polarisation directions of the incident wave at 90°) and it is capacitively linked to the resistive load in the vicinity of its centre, i.e. the area where the elements that constitute it converge, substantially located in the centre of the pixel in question.

The antenna advantageously consists of a metallic layer having a low sheet resistance, for instance a material selected from the group comprising Al, AlCu, AlSi, Ti.

According to another aspect of the invention, the resistive load and the thermometric element that suspends it are separated from the antenna by an air space or isolating vacuum or even an inert gas in order to provide capacitive coupling between the resistive load and the antenna. This improves the thermal isolation of the thermometer.

The resistive load is advantageously made of titanium nitride, has a thickness of several nanometers and is much smaller in size than the antenna and therefore has an extremely reduced heat capacity.

Finally, the thermometric element advantageously consists of a bolometric material, especially an amorphous silicon-based material or a vanadium or iron oxide-based material. Its ends are secured on posts capable of acting as electrical contacts with the substrate that contains the readout circuit as well as, as already stated, means of electrical excitation and pre-processing the electrical signals generated by detecting an electromagnetic wave. In contrast, the thermometric element is thermally isolated from said substrate by a vacuum and by virtue of the fact that thermometer which constitutes the suspension device can be highly electrically resistive and therefore highly thermally resistive and has a very small cross-sectional area in order to reduce thermal conduction by phonons.

Advantageously, one combines, within a single pixel, a bolometer that is sensitive to the electromagnetic radiation that is to be detected of the type described above with a compensation bolometer that is not sensitive to said radiation and which is referred to as a “blind” bolometer. Using such a compensation bolometer is known in itself and makes it possible to obtain common mode rejection. Such compensation bolometers, although insensitive to incident optical flux, are, in contrast, sensitive to the temperature of the substrate. Such a bolometer generates, in a known manner, a compensation current that is subtracted from the current obtained from the imaging bolometer, i.e. the detection bolometer, thanks to the way the electronic circuit is configured. This way, most of the current referred to as “common-mode current”, i.e. current which is not representative of information originating from the scene to be detected and is of electrical and thermal origin in the substrate, is eliminated.

### BRIEF DESCRIPTION OF THE DRAWINGS

The way in which the invention may be implemented and its resulting advantages will be made more readily understandable by the description of the following embodiment, given merely by way of example, reference being made to the accompanying drawings.

FIG. 1 is, as stated above, a schematic view of a bolometric detector with an antenna according to the prior state of the art.

FIG. 2 is a schematic cross-sectional view of a detector in accordance with the invention shown in a top view in FIG. 3.

FIG. 4 is a top view of one advantageous version of a detector according to the invention.

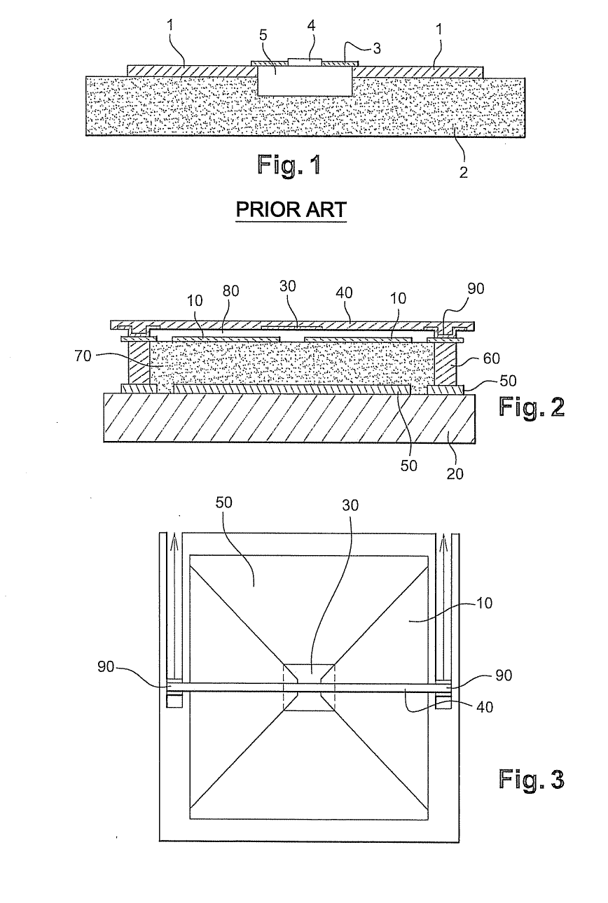

### DESCRIPTION OF THE PREFERRED EMBODIMENTS

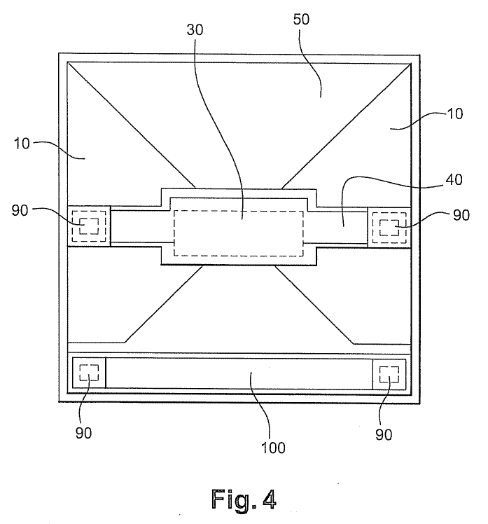

FIG. 2 shows a schematic cross-sectional view of an electromagnetic radiation detector in accordance with the invention. More especially, it shows one constituent pixel of such a detector.

This pixel is mounted on a substrate (20) which typically consists of a layer of silicon oxide SiO and a solid silicon Si substrate for example.

This substrate is also capable of being etched with a readout circuit that uses CMOS technology which is familiar to those skilled in the art.

A layer (50) designed to constitute a reflector is deposited on this substrate (20). This reflector comprises metallic layers having a low sheet resistance, for example layers made of materials selected from the group comprising Al, AlCu, AlSi, Ti. In a known manner, such a reflector is designed to reflect the wavelengths that are to be detected. This reflector is deposited on substrate (20) by sputtering, evaporation, Chemical Vapour Deposition (CVD) or any other technique for depositing thin-film metallic layers.

Advantageously, it covers as much as possible of the surface area of the pixel. In some particular cases, it may be structured, especially if the device is produced on the readout circuit or if it also acts as an electrical contact and, more especially, interconnects the thermometer to the external environment of the chip or underlying readout circuit.

One then defines an optical cavity (70) that is λ/4n thick, where n is the refractive index of the medium that constitutes said cavity. This creates, between antenna (10) deposited on said cavity and reflector (50) a quarter-wave space which is familiar to those skilled in the art in order to optimise absorption in the wavelength range in question.

This cavity has minimum absorption in the wavelength spectrum in question that one is attempting to detect through the actual antenna (10). Note that any losses in the cavity are at the expense of maximum absorption in the antenna load. It typically consists of a dielectric (SiO, SiN, etc.) but may also consist of silicon, an organic material (polyimide, benzocyclobutene-based polymer) or even a vacuum. The thickness of this optical cavity is determined by the specifications of the detector, especially in terms of its bandwidth, absorption wavelength and the material from which it is made. This thickness may typically vary from one micrometre to several dozen micrometres.

In addition, in the special case of detectors produced on the readout circuit, this cavity must also make it possible to produce a first set of posts, more precisely a first set of electrical contacts (60) suitable for ensuring reading of the bolometric resistance in the pixel by said readout circuit. In a known manner, electrical contacts (60) consist of an electrically conductive material such as titanium nitride or tungsten silicide. This material is deposited by Chemical Vapour Deposition (CVD) for instance.

The purpose of these posts is twofold: They are intended to fulfil the mechanical function of supporting the bolometer on the one hand and are designed to be used as electrical contacts with the substrate that contains the readout circuit on the other hand. In this latter case, they make it possible to electrically connect the bolometer and the substrate and, in particular, the bolometer and the readout circuit.

As indicated above, an antenna (10) is deposited on this cavity by Physical Vapour Deposition (PVD) for example, i.e. by sputtering) opposite reflector (50). This antenna also consists of metal layers having a low sheet resistance of the same type, for example, as the reflector. It is also structured in order to allow the detection of electromagnetic waves (bow-tie, spiral, etc.).

According to one essential aspect of the invention, a resistive load (30) intended to ensure capacitive coupling of the current generated in the antenna by the electromagnetic wave is suspended above antenna (10) by means of a thermometric element that consists here of a bolometric material (40) which therefore acts as a suspension beam or bar. In fact, because of this suspension arrangement, there is an air space or inert gas or a vacuum between antenna (10) and the assembly consisting of the bolometer (40) and resistive load (30).

As apparent in the Figures, resistive load (30) is centred relative to thermometric element (40).

Technically speaking, resistive load (30), bolometric layer (40) and a second portion of electrical contacts (90) are fitted after depositing a sacrificial layer (not shown) that is intended to be removed after the detector has been produced. This sacrificial layer is preferably organic (a polymer) so that it can be removed in an oxygen or nitrogen (plasma or non-plasma) atmosphere without damaging the other materials that are present (it is self-evident that these materials can be passivated in order to prevent their oxidation).

However, this sacrificial layer may also be made of amorphous carbon which is also compatible with oxygen etching. It may possibly be made of a porous oxide capable of being removed by hydrofluoric acid in the vapour phase.

It should be noted that this sacrificial layer method can also be used to produce an empty cavity underneath the antenna which is supported by posts.

The thickness of the air space or vacuum (80) thus produced is typically 0.1 to several micrometres. In the case of a vacuum cavity, the thickness will obviously be the distance between the antenna and the reflector.

Above-mentioned resistive load (30) consists of a very thin material having a sheet resistance of several hundred Q per square, typically 200-400Ω per square, so as to minimise the calorific mass of the detector in accordance with the invention. This resistive load can be made of titanium nitride that is several nanometres thick and deposited on the above-mentioned sacrificial layer by sputtering. It is located facing antenna (10) and, more precisely, facing the convergence zones of said antenna if the latter has a bow-tie shape. Note that, in this embodiment, the second portion of electrical contacts (90) is produced using the same material as the resistive load.

This load can have a square or rectangular shape. As shown in FIG. 4, in the case of a rectangular configuration, the larger dimension of the rectangle extends in the direction of the antenna and; more especially, in the direction in which the antenna is deployed if it has a bow-tie shape.

Bolometric material (40) which is intended to act as a thermometer is therefore, as shown in FIG. 2, in contact with resistive load (30). As already stated, the temperature of this bolometric material (40) is intended to rise as a function of the electromagnetic flux absorbed by the load which is coupled to the antenna/cavity/reflector assembly. It is typically made of amorphous silicon or an oxide, especially vanadium or iron oxide so that it has a coefficient T_{cr} of several % per degree and continuously represents variation in resistance as a function of temperature. It typically has a coefficient T_{cr} of around 2%/° C.

According to one aspect of the invention, bolometric material (40) is in the form of a beam or bar, as illustrated more clearly in FIG. 3, and also fulfils the function of suspending resistive load (30) above antenna (10) and optical cavity (70).

It is readily understandable that beams or bars (40) made of the bolometric material not only physically suspend resistive load (30), they also provide thermal isolation and thermometric electrical resistance.

To the extent that the heat capacity of said resistive load (30) is reduced, said beams (40) can have a higher thermal resistance while still retaining a high thermal bandwidth.

In the surface of an optical pixel having a pitch of 30 μm comprising nine antennas, said antennas can be of different kinds so as to allow detection polarised in transverse electric (TE) mode and transverse magnetic (TM) mode and/or detection in two or three spectral bands (even if these overlap) by influencing the thickness of the optical cavity and/or by cross correlating measurements which also makes it possible to reject common mode noise of electrical or thermal origin.

In imaging, a point of the observed scene can be detected by the optics of the instrument on an optical pixel (picture element) comprising, for example, 3×3 antennas having a pitch of 10 μm (depending on the wavelength range in question). By virtue of their construction, these antennas can be different, for example bow-tie type in one direction. One then measures the flux emitted by the scene in a perpendicular direction. The antennas of the optical pixel can also be of different sizes. This way, each of the antennas can ensure detection in different wavelength bands: principle of a multi-spectrum VIS detector (RGB, red, green, blue).

One of the antennas can be blind, i.e. the received flux does not cause the temperature of the corresponding bolometer to rise because it is a so-called compensation bolometer (cf. below). Differential measurement is performed on this bolometer and the other bolometers of the optical pixel, thus making it possible to reject noise or common mode interference.

Because the antenna spacing pitch is less than the wavelength, for wide-aperture optics (focal length F approximately 1) that are limited by diffraction, spatial sampling of the image is correct and even very high resolution. Moreover, large sized arrays can be realised while minimising cost (especially by reducing the silicon surface area).

In fact, for an f-number of 1 (ratio of focal length F to lens diameter D), diffraction is:

1.22λ.F/D

and sampling is correct according to the Shannon criterion if the optical-pixel pitch is half the diffraction pattern.

For applications where the detector is exposed to ionising particles (in space-based applications in particular), the antenna and reflector are not sensitive to these particles and the sensitive area (resistive load and beams) has a markedly reduced surface area because of this. For an optical pixel having 3×3 antennas, one can identify one of the calorimeters affected by a particle or a high-energy photon and thus average out the measurements over the other pixels, the gain is 8/9 relative to 0 for a sensor that conforms to the optical pitch.

By stress relieving the beams or polarising the reflector, one can produce a controlled electrostatic force on the load, thereby adjusting or modulating capacitive coupling, i.e. the distance of the air gap, and thus the optical coupling of the structure.

The spectral response of the bolometer can be modified in this way.

In fact, when producing the detector in accordance with the invention, one successively deposits the antenna (SiN), the thermometer and the resistive load (TiN) in the centre of the beam on a sacrificial layer made up polyimide for example. This set of layers is stressed (in compression or tension) on the polyimide layer firstly because of temperature variations when the deposition method is performed (heating, then return to ambient temperature) and secondly because of shrinkage of said sacrificial polyimide layer.

When the sacrificial layer contracts, the beam is released in the air and can deflect in the direction of the antenna or, conversely, deflect away from it. This modifies the air gap, i.e. the distance between the beam or the load of the antenna and, concomitantly, the capacitive coupling between the load and the antenna. This air gap is filled by an electrostatic force between the reflector and the load.

According to one advantageous aspect of the invention that is shown in FIG. 4, a blind bolometer (100), which is also referred to as a compensation bolometer, is combined with the sensitive bolometer.

Thus, as stated in the preamble, such a compensation bolometer makes it possible to reject common-mode current produced by the signal originating from substrate (20), hence only retaining the signal originating from the detected scene as the processed signal. In this configuration, compensation bolometer (100) is not associated with a resistive load. In addition, it is not associated with an antenna either.

1-13. (canceled)

14. A bolometric detector for detecting electromagnetic radiation comprising:
a receiving antenna intended for collecting electromagnetic radiation and thus ensuring electromagnetic coupling;
a resistive load capacitively coupled to said antenna and capable of converting the electromagnetic power collected into calorific power;
a thermometric element connected to said resistive load and thermally isolated from a substrate, the latter being capable of accommodating an electronic circuit that includes means of electrical excitation (stimulus) and pre-processing the electrical signals generated by said detector;
wherein the resistive load is suspended above the receiving antenna by means of a single thermometric element which is itself electrically and mechanically linked to the substrate; and
wherein the resistive load has a surface area that is less than 1% of the surface area of the receiving antenna.

15. The bolometric detector for detecting electromagnetic radiation as claimed in claim 14, wherein the resistive load is centred relative to the thermometric element.

16. The bolometric detector for detecting electromagnetic radiation as claimed in claim 14, wherein the resistive load has a square or rectangular shape, the larger dimension of the rectangle being in the main direction in which the antenna extends.

17. The bolometric detector for detecting electromagnetic radiation as claimed in claim 14, wherein the substrate accommodates a layer of reflective material that is separated from the receiving antenna by an optical cavity made of a dielectric, semiconductor or organic material or consisting of a vacuum.

18. The bolometric detector for detecting electromagnetic radiation as claimed in claim 17, wherein the thickness of the optical cavity is of the order of λ/4n, where n is the refraction index of the material that constitutes the cavity and λ is the average wavelength of the detection domain in question.

19. The bolometric detector for detecting electromagnetic radiation as claimed in claim 14, wherein the receiving antenna has a bow-tie, double bow-tie or spiral shape and in that said antenna and resistive load are capacitively linked in the vicinity of the centre of the antenna, i.e. the zone where the constituent elements of the antenna converge.

20. The bolometric detector for detecting electromagnetic radiation as claimed in claim 14, wherein the receiving antenna consists of a metal layer having a low sheet resistance and is advantageously made of a material selected from the group comprising Al, AlCu, AlSi, Ti.

21. The bolometric detector for detecting electromagnetic radiation as claimed in claim 14, wherein the resistive load and the thermometric element that suspends it above the receiving antenna are separated from said antenna by an isolating air space or vacuum or even an inert gas.

22. The bolometric detector for detecting electromagnetic radiation as claimed in claim 14, wherein the resistive load is made of titanium nitride and has a thickness of several nanometres.

23. The bolometric detector for detecting electromagnetic radiation as claimed in claim 14, wherein the thermometric element consists of a bolometric material advantageously selected from the group comprising amorphous silicon and oxides of vanadium and iron.

24. The bolometric detector for detecting electromagnetic radiation as claimed in claim 14, wherein the thermometric element which is in the form of a beam or bar is supported at it ends on posts in electrical contact with the substrate but is thermally isolated from the latter.

25. A bolometric detector for detecting electromagnetic radiation wherein it combines, within a single pixel, a bolometer that is sensitive to the electromagnetic radiation to be detected in accordance with claim 14 with a compensation bolometer that is not sensitive to said radiation and is designed to reject common mode current originating from substrate of electrical or thermal origin.
